(19) United States
(12) Patent Application Publication
(10) Pub. No.: US 2005/0235699 A1
(43) Pub. Date: Oct. 27, 2005

(54) Press forming machine for glass

(76) Inventors: Satoshi Fukuyama, Numazu (JP); Shigeru Fujiwara, Numazu (JP); Yuki Sugiura, Mishima (JP)

Correspondence Address: DLA PIPER RUDNICK GRAY CARY US LLP, P. O. BOX 9271, RESTON, VA, 20195, US

(21) Appl. No.: 11/113,998

(22) Filed: Apr. 26, 2005

(30) Foreign Application Priority Data
Apr. 26, 2004 (JP) 2004-129210

(51) Int. Cl. C03B 11/16

(52) U.S. Cl. 65/158; 65/161; 65/162

(57) ABSTRACT

Inert gas is supplied from a supply source to the interior of a forming chamber through lines and gas supply routes. Variable flow control valves are provided in the middle of the lines and are controlled by a command from a control unit. The variable flow control valves vary pressure or flow rate of the inert gas in accordance with a command value to be sent every moment from the control unit such that the pressure or flow rate gradually reach a target value. According to the present invention, the pressure in the forming chamber is not varied abruptly when supply of the inert gas is stopped or the setting of flow rate thereof is changed. As a result, fluctuation in output of a load cell 8b can be suppressed and high precision of pressing force can be secured.

### CROSS-REFERENCE TO RELATED APPLICATIONS

This application is based upon and claims the benefit of priority from prior Japanese Patent Application No. 2004-129210, filed Apr. 26, 2004, the entire contents of which are incorporated herein by reference.

### BACKGROUND OF THE INVENTION

1. Field of the Invention

This invention relates to a press forming machine for glass and, more particularly, to a press forming machine suitable for manufacturing glass products such as high-precision optical lenses.

2. Description of the Related Art

FIG. 2 shows a conventional press forming machine for glass. This machine is disclosed in Jpn. Pat. Appln. KOKAI Publication No. 8-208243. A fixed axis 2 extends downwardly from a top portion of a machine frame 1. An upper die assembly 4 (fixed die) is attached to a lower end portion of the fixed axis 2 via a heat insulating block 3 made of ceramic. A screw jack 8 and a servomotor 8a serving as a drive source thereof are provided at a lower portion of the machine frame 1. A moving axis 9 is connected to a top portion of the screw jack 8 via a load cell 8b and extends upwardly from the lower portion of the machine frame 1 so as to oppose to the fixed axis 2. A lower die assembly 11 (moving die) is attached to an upper end portion of the moving axis 9 via a heat insulating block 10 made of ceramic.

The upper die assembly 4 includes a die plate 5 made of metal, a core 6 made of ceramic (or superhard alloy), and an upper die 7. The upper die 7 fixes the core 6 on the die plate 5 and serves as a part of the face of the die assembly 4. Similarly, the lower die assembly 11 includes a die plate 12 made of metal, a core 13 made of ceramic (or superhard alloy), and a lower die 14. The lower die 14 fixes the core 13 on the die plate 12 and serves as a part of the face of the die assembly 11.

An upper plate 15 is attached to an outer periphery of the fixed axis 2. The upper plate 15 is in contact with the outer periphery of the fixed axis 2 airtightly and is slidable along the fixed axis 2. The upper plate 15 is moved up and down by a driving unit (not shown). A transparent quartz tube 16 is attached to a bottom surface of the upper plate 15 so as to surround the upper die assembly 4 and the lower die assembly 11. A lower end of the quartz tube 16 is in contact with a top surface of a middle plate 1a airtightly. A forming chamber 17 is thereby formed in the quartz tube 16.

Moreover, an outer cylinder 18 is attached to the bottom surface of the upper plate 15 so as to surround the quartz tube 16. A lamp unit 19 (heater) which heats an interior of the forming chamber 17 is attached to an inner wall surface of the outer cylinder 18. The lamp unit 19 includes an infrared lamp 20, a reflector 21 arranged behind the infrared lamp 20, a water-cooling pipe 22 which cools the reflector 21, and air-cooling nozzles (not shown) which blow cooling air onto an outer periphery of the quartz tube 16.

Gas supply routes 23 and 24 are formed in the fixed axis 2 and the moving axis 9, respectively. An inert gas such as N₂ gas is supplied from a supply source (not shown) to the forming chamber 17 through the gas supply routes 23 and 24 and the heat insulating blocks 3 and 10 in turn. Thus, the interior of the forming chamber 17 becomes an inert atmosphere or the upper die assembly 4 and the lower die assembly 11 are cooled. In addition, a gas supply route 25 is formed through the upper plate 15. The inert gas is directly supplied to the forming chamber 17 through the gas supply route 25. An outlet 26 is formed through the middle plate 1a which serves as the lower portion of the forming chamber 17. The inert gas supplied to the forming chamber 17 is discharged outside the forming chamber 17 through the outlet 26.

A press forming process employing the press forming machine for glass can be explained below in brief. The inert gas is supplied to the forming chamber 17 through the gas supply routes 23, 24 and 25 such that the interior of the forming chamber 17 becomes an inert gas atmosphere. Then, an output of the lamp unit 19 is controlled by a control unit 28 while the temperature of the lower die assembly 11 is detected by a thermocouple 27 (A thermocouple is also attached to the upper die assembly 4 though it is not shown in the figure.). Thus, the upper die assembly 4, the lower die assembly 11 and a preform 30 are heated.

After the temperature of the lower die assembly 11 reaches a predetermined value, the moving axis 9 is raised under a preprogrammed sequence and the preform 30 is subjected to press forming. At this time, the speed, pressing force or position of the moving axis 9 is controlled by controlling the speed, torque or revolution of the servomotor 8a under the preprogrammed sequence by the control unit 28. After the press forming, the inert gas is supplied to the forming chamber 17 through the gas supply routes 23 and 24 while a predetermined pressing force is applied to the moving axis 9. Thus, the upper die assembly 4, the lower die assembly 11 and the formed product 30 located therebetween are cooled at a predetermined cooling speed.

Incidentally, in the conventional press forming machine for glass as disclosed in Jpn. Pat. Appln. KOKAI Publication No. 5-319841, flow rate of the inert gas supplied to the forming chamber 17 is controlled at a predetermined value in accordance with temperature lowering speed at the cooling. However, the start or stop of the inert gas supply and the changing of the flow rate thereof is carried out under on-off type control. For this reason, the pressure in the forming chamber 17 fluctuates abruptly in accordance with the start or stop of the inert gas supply and the changing of the flow rate thereof, vibration is thereby induced to the output of the load cell 8b and product defects are thereby caused. As a result, high-precision press forming for glass cannot be executed.

### BRIEF SUMMARY OF THE INVENTION

The present invention has been accomplished to solve the above-described problems in the conventional press forming machine for glass.

A press forming machine for glass, according to an aspect of the present invention, comprises a forming chamber; a fixed axis arranged in the forming chamber to retain a fixed die; a moving axis arranged opposite to the fixed axis in the forming chamber, to retain a moving die; a heater which heats the interior of the forming chamber; a gas supply route through which inert gas is supplied to the forming chamber; a gas supply source connected to an upstream end of the gas supply route; a load cell which detects pressing force to be applied between the fixed die and the moving die; and a control unit which controls the heater and the gas supply route and which drives the moving axis by controlling speed, pressing force or position thereof. A variable flow control valve which is controlled by the control unit and which is configured to gradually increase or decrease pressure or flow rate of the inert gas supplied to the forming chamber up to a target value is provided in a line connecting the gas supply source and the gas supply route.

Preferably, the variable flow control valve continuously varies the pressure or flow rate in accordance with a command value to be sent every moment from the control unit.

In this case, preferably, the control unit sends the command value to the variable flow control valve such that the pressure or flow rate gradually reaches the target value in a curved pattern.

Instead of this, when the target value is sent from the control unit to the variable flow control valve, the variable flow control valve may vary the pressure or flow rate such that the pressure or flow rate gradually reaches the target value.

In this case, preferably, the variable flow control valve varies the pressure or flow rate such that the pressure or flow rate gradually reaches the target value in a curved pattern.

According to the present invention, the pressure in the forming chamber 17 is not varied abruptly when supply of the inert gas is stopped or the setting of flow rate is changed. As a result, fluctuation in output of a load cell can be suppressed, high precision of pressing force can be secured, and press forming for glass which is excellent in accuracy of dimensions and accuracy of shape can be implemented.

### BRIEF DESCRIPTION OF THE SEVERAL VIEWS OF THE DRAWING

FIG. 1 shows a press forming machine for glass according to the present invention; and

FIG. 2 shows a conventional press forming machine for glass.

### DETAILED DESCRIPTION OF THE INVENTION

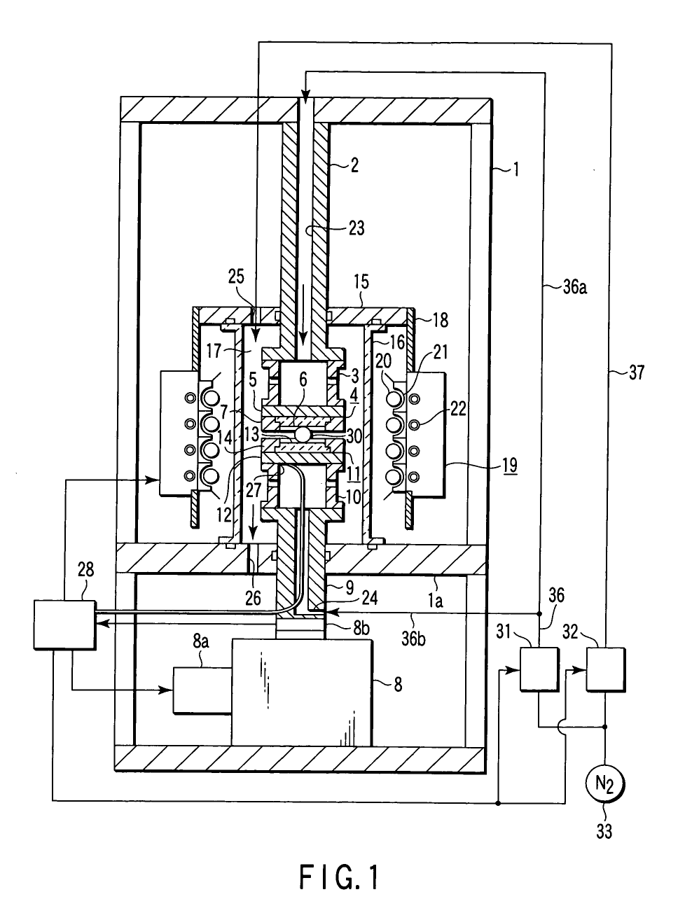

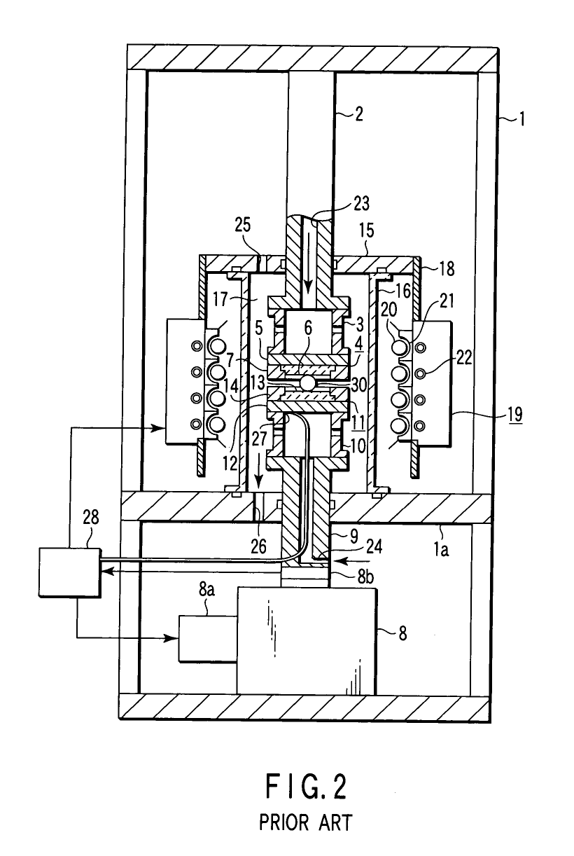

An embodiment of the present invention will be explained below with reference to the accompanying drawing. FIG. 1 shows an embodiment of the press forming machine for glass according to the present invention. In the press forming machine of FIG. 1, unlike the machine shown in FIG. 2, variable flow control valves 31, 32 capable of smoothly varying the pressure or the flow rate are provided between an inert gas supply source 33 and the gas supply routes 23, 24, 25. The press forming machine of FIG. 1 is common in the other constituent elements to the machine of FIG. 2. Thus, elements like or similar to those in FIG. 2 are denoted by similar reference numbers and their explanations are omitted.

An upstream side of the gas supply route 23 provided in the fixed axis 2 is connected to the inert gas supply source 33 (for example, a N₂ gas cylinder) via a line 36a, a line 36 and the variable flow control valve 31 in turn. Similarly, an upstream side of the gas supply route 24 provided in the moving axis 9 is connected to the inert gas supply source 33 via a line 36b, the line 36 and the variable flow control valve 31 in turn. Furthermore, an upstream end of the gas supply route 25 formed through the upper plate 15 is connected to the inert gas supply source 33 via a line 37 and the variable flow control valve 32 in turn. The pressure or flow rate of the inert gas supplied to the forming chamber 17 through the lines 36, 37 is controlled by the variable flow control valves 31, 32.

The variable flow control valves 31, 32 have a function of continuously varying the pressure or flow rate of the inert gas in accordance with command values to be sent every moment from the control unit 28. The pressure or flow rate of the inert gas supplied to the forming chamber can be thereby gradually increased or decreased to a target value.

Next, a press forming process employing the press forming machine for glass is explained. The process is the same as the above-explained process of the prior art (FIG. 2), except controlling the pressure or flow rate of the inert gas by employing the variable flow control valves 31, 32. Therefore, only the process relating to the supply of the inert gas by the variable flow control valves 31, 32 is explained here.

When the press forming is started, the variable flow control valves 31, 32 are opened to supply the inert gas to the forming chamber 17 through the gas supply routes 23, 24, 25 and make the inert gas atmosphere in the forming chamber 17. Then, the output of the lamp unit 19 is controlled by the control unit 28 to heat the upper die assembly 4, the lower die assembly 11 and the preform 30.

At this time, preferably, the moving axis 9 is raised with a small pressing force such that the preform 30 is sandwiched between the upper die assembly 4 and the lower die assembly 11, to promote the rise in temperature of the preform 30. If the inert gas is supplied to the forming chamber 17 under an on-off type control, the pressure in the forming chamber 17 is abruptly varied, vibration is induced to the output of the load cell 8b attached to the moving axis 9 and the pressing force caused by the moving axis 9 is fluctuated. In this machine, however, the variable flow control valves 31, 32 vary the pressure (or flow rate) of the inert gas in accordance with the command from the control unit 28 such that the pressure (or flow rate) gradually reaches the target value while drawing a predetermined curve. Thus, the pressure in the forming chamber 17 is not abruptly varied and vibration is not applied to the output of the load cell 8b. As a result, the preform 30 can be sandwiched between the upper die assembly 4 and the lower die assembly 11 with a stable pressing force.

After the temperature of the preform 30 has reached the predetermined temperature, the pressing force of the moving axis 9 is increased to further raise the moving axis 9 such that the preform 30 is subjected to press forming between the upper die assembly 4 and the lower die assembly 11. After the press forming, the amount of the inert gas supplied through gas supply routes 23, 24 is increased and the upper die assembly 4, the lower die assembly 11 and the formed article 30 sandwiched therebetween are cooled while a predetermined pressing force is applied to the moving axis 9. At this time, too, in accordance with the command from the control unit 28, the pressure (or flow rate) of the inert gas is gradually varied by the variable flow control valves 31 to acquire a predetermined cooling speed. Thus, the pressure in the forming chamber 17 is not abruptly varied and vibration is not applied to the output of the load cell 8b. As a result, a glass article can be formed with high accuracy.

In the above-described embodiment, the variable flow control valves 31, 32 gradually increase or decrease the pressure (or flow rate) of the inert gas in accordance with the command value which is sent every moment from the control unit 28. As a modified example, however, the variable flow control valves 31, 32 themselves may have a function of gradually increasing or decreasing the pressure (or flow rate) of the inert gas. In this case, the target value (final value) alone is supplied from the control unit 28 to the variable flow control valves 31, 32 and the variable flow control valves 31, 32 vary the pressure (or flow rate) of the inert gas such that the pressure (or flow rate) thereof gradually reaches the target value.

According to the press forming machine for glass, of the present invention, abrupt variation in the pressure in the forming chamber can be suppressed and the pressing force can be controlled more exactly. As a result, manufacturing the high-precision glass product such as a glass lens which requires exact control of the pressing force can be conducted.

1. A press forming machine for glass, comprising:
a forming chamber;
a fixed axis arranged in the forming chamber to retain a fixed die;
a moving axis arranged opposite to the fixed axis in the forming chamber, to retain a moving die;
a heater which heats the interior of the forming chamber;
a gas supply route through which inert gas is supplied to the forming chamber;
a gas supply source connected to an upstream end of the gas supply route;
a load cell which detects pressing force to be applied between the fixed die and the moving die; and
a control unit which controls the heater and the gas supply route and which drives the moving axis by controlling speed, pressing force or position of the moving axis,
wherein a variable flow control valve which is controlled by the control unit and which is configured to gradually increase or decrease pressure or flow rate of the inert gas supplied to the forming chamber up to a target value is provided in a line connecting the gas supply source and the gas supply route.

2. The machine according to claim 1, wherein the variable flow control valve continuously varies the pressure or flow rate in accordance with a command value to be sent every moment from the control unit.

3. The machine according to claim 1, wherein the control unit sends the command value to the variable flow control valve such that the pressure or flow rate gradually reaches the target value in a curved pattern.

4. The machine according to claim 1, wherein when the target value is sent from the control unit to the variable flow control valve, the variable flow control valve varies the pressure or flow rate such that the pressure or flow rate gradually reaches the target value.

5. The machine according to claim 4, wherein the variable flow control valve varies the pressure or flow rate such that the pressure or flow rate gradually reaches the target value in a curved pattern.
